(19) United States
(12) Patent Application Publication
(10) Pub. No.: US 2005/0097060 A1
(43) Pub. Date: May 5, 2005

(54) Method for electronic commerce using security token and apparatus thereof

(76) Inventors: Joo Young Lee, Daejeon-city (KR); Ki Young Moon, Daejeon-city (KR); Sung Won Sohn, Daejeon-city (KR); Chee Hang Park, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/863,735

(22) Filed: Jun. 7, 2004

(30) Foreign Application Priority Data
Nov. 4, 2003 (KR) 2003-77753

(51) Int. Cl. H04L 9/00

(52) U.S. Cl. 705/65

(57) ABSTRACT

A method for electronic commerce using a security token and an apparatus thereof are provided. The electronic commerce method using a security token comprises a transaction approval institution generating a security token based on a security assertion markup language (SAML), using credit information of a purchaser who requests to issue a security token, and transmitting the security token to the purchaser; the purchaser writing an electronic signature on an order and transmitting the order together with the security token to a seller; the seller verifying the received order and security token, and then delivering goods according to the order to the purchaser; and the transaction approval institution performing payment for the seller and the purchaser. The method can solve the problems of personal information leakage and privacy infringement that may happen when a purchaser sends his personal information to a seller for electronic commerce. Since the token is one-time-use data, even if a security token sent is counterfeited or stolen, the loss can be minimized. In addition, by writing an extensible markup language (XML) electronic signature in the security token, authentication, integrity, and non-repudiation for a transmitted message can be guaranteed and through simple object access protocol (SOAP) security technology, confidentiality is maintained.

This application claims priority from Korean Patent Application No. 03-77753, filed Apr. 11, 2003, the contents of which are incorporated herein by reference in their entirety.

### BACKGROUND OF THE INVENTION

1. Field of the Invention

The present invention relates to an electronic commerce method and a system thereof, and more particularly, to a method and system which enables secure electronic commerce by exchanging a security token containing various information needed in purchaser's electronic commerce.

2. Description of the Related Art

Electronic payment is an act of paying the price of goods purchased in electronic commerce by electronic money. An electronic payment system is a system of information transfer and bill payment by which purchasers and sellers involved in transactions can pay and receive, respectively, the price of services and goods securely and effectively. In other words, the electronic payment system is a kind of solution formed with hardware and software for performing a series of bill payment process for electronic commerce. The electronic payment system can be broken down into a prepay system, a direct system, and a post-payment system by payment time, into an online system and an offline system by authentication time, and into a high-volume system and a micro payment system by transaction volume.

In an electronic payment method widely used in electronic commerce at present, purchaser's credit card number, resident registration number, password, and the like are requested to be transmitted to a shopping server, and then, after a credit card company approves the payment and pays the bill, the transaction is completed. However, this method provides personal information, including credit card information, passwords, and resident registration numbers, to shopping servers over the Internet such that there is a risk of infringement of privacy and leakage of important personal information and security problems including guaranteeing safe management of transferred information arise.

In order to solve these problems, electronic payment methods using cryptography or electronic signatures, and electronic payment service methods using electronic wallets have been suggested so far. However, in most of these methods, for payment during shopping over the web, socket communication methods should be used or new software such as electronic wallets should be installed and a compatibility problem among numerous different systems on the web arises. Accordingly, it is difficult for purchasers to perform smooth transactions and a lot of cost is needed for integration with existing software.

Therefore, for electronic payment, security services that can be relied on by purchasers, such as authentication, confidentiality, integrity, and non-repudiation, should be provided and in addition, an electronic payment method which provides compatibility enabling to transact with numerous different systems on the web and easy integration with existing system, is necessarily needed.

### SUMMARY OF THE INVENTION

The present invention provides an electronic commerce method using a secure web-browser-based security token by which a purchaser does not need to worry about personal information leakage.

The present invention also provides a method and apparatus for generating a security token for performing safe electronic commerce by which a purchaser does not need to worry about personal information leakage.

The present invention also provides a recording medium having embodied thereon a computer program for an electronic commerce method using a secure web-browser-based security token by which a purchaser does not need to worry about personal information leakage.

According to an aspect of the present invention, there is provided an electronic commerce method using a security token comprising: a transaction approval institution generating a security token based on a security assertion markup language (SAML), using credit information of a purchaser who requests to issue a security token, and transmitting the security token to the purchaser; the purchaser writing an electronic signature on an order and transmitting the order together with the security token to a seller; the seller verifying the received order and security token, and then delivering goods according to the order to the purchaser; and the transaction approval institution performing payment for the seller and the purchaser.

According to another aspect of the present invention, there is provided an electronic token generation method of an electronic transaction approval institution based on credit information of a purchaser comprising: generating a one-time-use security token based on an XML; writing an electronic signature in the security token; and encrypting the electronically signed security token as a part of POST payload and transmitting to the purchaser.

According to still another aspect of the present invention, there is provided a security token generation system comprising: a customer information storage unit which stores customer information; a security token generation unit which if a security token generation request signal is input, searches the customer information storage unit and performs authentication and then outputs a one-time-use security token; and an electronic signature unit which receives the security token, writes an electronic signature, and outputs the security token to the customer requesting to issue the security token.

### BRIEF DESCRIPTION OF THE DRAWINGS

The above objects and advantages of the present invention will become more apparent by describing in detail preferred embodiments thereof with reference to the attached drawings in which:

FIG. 1 is a diagram of the structure of an electronic commerce system using a security token according to the present invention;

FIG. 2 is a flowchart of the steps performed by a security token generation method according to the present invention; and

FIG. 3 is a flowchart of the steps performed by en electronic payment method using a security token according to the present invention.

### DESCRIPTION OF THE PREFERRED EMBODIMENTS

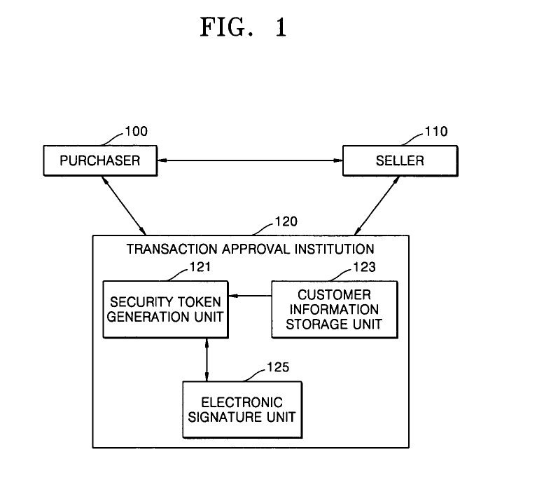

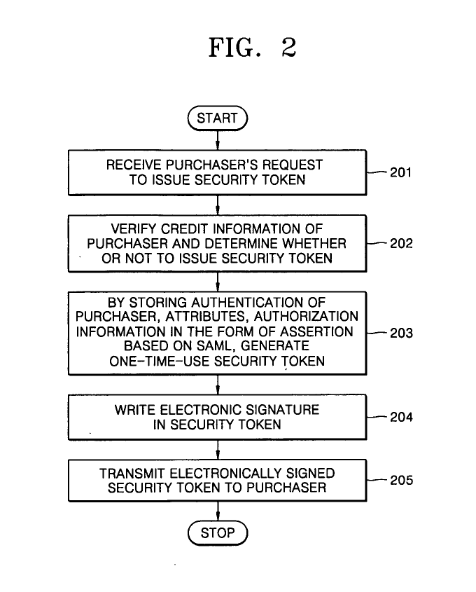

Referring to FIGS. 1 and 2, the electronic commerce system comprises a purchaser 100 who searches sales goods of a seller 110 and buys goods, and a transaction approval institution 120 which in response to a transaction approval request of the purchaser 100 generates a security token, transmits the token to the purchaser 100 so that the purchaser 100 can perform transactions based on the security token, pays the price to the seller 110, and sends the bill to the purchaser 100. Here, the transaction approval institution 120 corresponds to a bank or a payment gateway.

The operation of the transaction approval institutions and a process for generating a security token will now be explained. A security token generation unit 121 receives a request for a security token from the purchaser 100 who desires transactions in step 201. After receiving the request of a security token, the security token generation unit 121 performs authentication for a purchase approval by confirming credit information on the purchaser stored in a customer information storage unit 123 in step 202. If the credit of the purchaser is authenticated, information on the authentication, attributes, and approval of the purchaser is stored in a data structure, called Assertion, based on a security assertions markup language (SAML) and a one-time-use security token is output in step 203.

Here, the SAML will now be explained. The present invention uses the SAML, the standard for security information exchange between different systems in order to generate and provide a security token of a purchaser. Since the SAML expresses and transmits data using a simple object access protocol (SOAP) on the extensible markup language (XML) and hypertext transfer protocol (HTTP), which are used today as standards of web documents, exchanging documents and data complying with this standard has advantage that compatibility can be maintained without using additional programs or packages and easy integration with existing systems is provided.

An electronic signature unit 125 receives the one-time-use security token, calculates a digest value by performing message digestion, and encrypts the value by using a private key of the electronic transaction approval institution 120, and by doing so, ultimately writes an electronic signature in step 204. The electronic signature unit 125 uploads the electronically signed security token in the form of the hypertext markup language (HTML) on a web browser, and transfers the token as a part of a POST payload to the purchaser, and in the transferring, a transmission protocol, to which a security method is applied, is used in step 205.

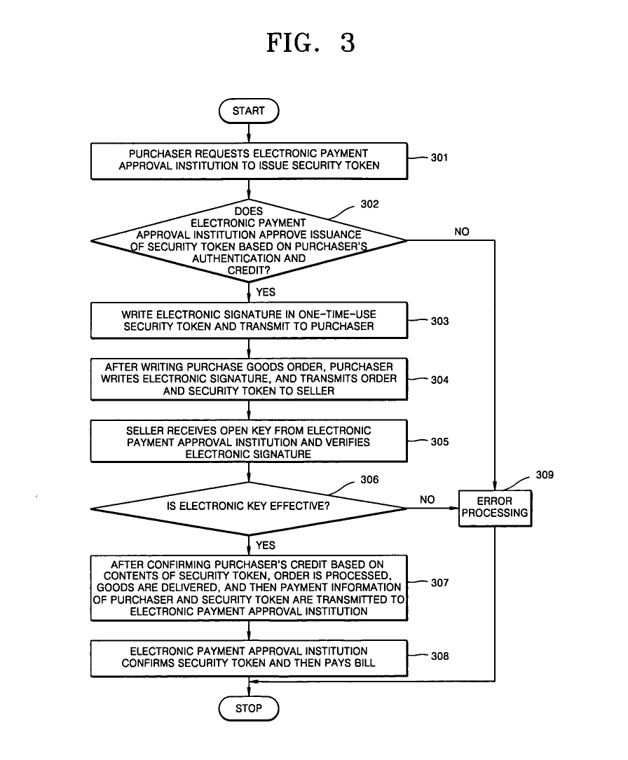

A preferred embodiment of an electronic commerce method using thus generated security token will now be explained referring to FIG. 3. The structure of a system, to which the electronic commerce method using a security token is applied, comprises the purchaser 100, the seller 110, and the transaction approval institution 120 such as a bank or a credit card company, connected through a communications network, as shown in FIG. 1.

In the structure described above, the electronic payment method using a security token can be broadly divided into a step for requesting issuance of an electronic token, a step for issuing and transmitting an electronic token through user authentication and credit information confirmation, a step for transmitting a purchase order and a security token, a step for verifying the security token and processing the purchase order, a step for delivering goods and bill payment, and a step for transmitting the payment result. These will now be explained in detail.

First, the purchaser 100 who wants a transaction on a communications network (for example, the Internet) requests the transaction approval institution 120 (for example, a bank or a credit card company) to issue a security token guaranteeing his purchase capability and credit in step 301. After receiving the request, the transaction approval institution 120 performs authentication and confirms the credit of the purchase 100 based on the credit information of the purchaser 100 retained by the institution 120. In step 302, if the authentication is not successful or it is determined that due to the low credit of the purchaser 100, the transaction cannot be approved, the request is processed as an error, and if the authentication is successful, a step for generating a security token is performed. If the credit of the purchaser 100 is confirmed, information on the authentication, attributes, and approval of the purchaser is stored in a data structure, called Assertion, based on the SAML, and a one-time-use security token is generated. An electronic signature is written in this security token, by performing message digestion for the security token, and encrypting the calculated digest value by using a private key of the transaction approval institution 120. The electronically signed security token is uploaded in the form of the HTML on a web browser, and transferred to the purchaser 100 as a part of a POST payload. At this time, a transmission protocol, to which a security method is applied, is used in step 303.

The purchaser 100 receives the security token and stores it. The purchaser 100, who is searching an Internet shopping mall, writes an order for goods desired to be purchased, and partially writes an electronic signature for the price to be paid, and by doing so, confirms the purchase detail and the amount payable. Also in this case, an Internet protocol, to which a security method is applied, is used in step 304.

The seller 110 who receives the order and security token obtains an authentication document for a public key of the transaction approval institution 120, which wrote the electronic signature, in order to confirm the contents included in the security token. If the authentication document is valid, the electronic signature is verified in order to confirm that the security token is not counterfeited or modified during the transmission. For this, the following three steps are performed. First, the electronic signature included in the security token is decrypted by using the public key of the transaction approval institution 120. As a result, a message digest value is obtained. As the next step, message digestion for this security token is performed. As the last step, it is confirmed that message digest values obtained in the two steps are identical. If the two values are identical, it means the verification is successful, and with this, it is confirmed that there is no counterfeiting or modifying the security token during the transmission in step 306.

If the verification is successful, the credit is confirmed based on the authentication and attribute information of the purchaser 100 stored in the security token. After the credit is confirmed, the details of the order placed by the purchaser 100 are processed. That is, the seller 110 delivers the goods ordered by the purchaser 100 to the purchaser 100, and then, by transmitting the security token together with payment information electronically signed by the purchaser 100, to the transaction approval institution 120 of the purchaser 100, asks bill payment in step 307.

After receiving the request, the transaction approval institution 120 confirms the security token, pays the bill, and then sends the payment result to the purchaser 100 in step 308. Thus, the electronic transaction using the security token is completed.

As described above, the purchaser 100 requests the electronic transaction approval institution 120 to issue a security token guaranteeing the credit of the purchaser 100, and the one-time-use security token issued according to the request is transmitted to the purchaser 100. By transmitting an order electronically signed by the purchaser 100 together with the security token, the purchaser 100 can remove the problems of security and privacy infringement that may happen during a process transmitting personal information such as the credit card number and resident registration number of the purchaser 100. Also, through the process confirming the transmitted security token, then processing the details of the order and requesting bill payment to the transaction approval institution of the purchaser 100, the seller 110 can obtain a guaranteed credit of the purchaser 100 such that the seller 110 can increases sales without worrying about collecting the amount receivable.

The electronic commerce method using a security token and a method for an electronic transaction party generating a security token according to the present invention may be embodied in a code, which can be read by a computer, on a computer readable recording medium. The computer readable recording medium includes all kinds of recording apparatuses on which computer readable data are stored. The computer readable recording media includes ROMs, RAMs, CD-ROMs, magnetic tapes, hard disks, floppy disks, flash memories, and optical data storage devices. Also, the computer readable recording media can be scattered on computer systems connected through a network and can store and execute a computer readable code in a distributed mode. Also, the font ROM data structure according to the present invention can be implemented as computer readable codes on a computer readable recording medium such as ROMs, RAMs, CD-ROMs, magnetic tapes, hard disks, floppy disks, flash memories, and optical data storage devices.

As described above, the electronic commerce method using a security token according to the present invention can solve the problems of personal information leakage and privacy infringement that may happen when a purchaser sends his personal information to a seller for electronic commerce. Since the token is one-time-use data, even if a security token sent is counterfeited or stolen, the loss can be minimized. In addition, by writing an XML electronic signature in the security token, authentication, integrity, and non-repudiation for a transmitted message can be guaranteed and through SOAP security technology, confidentiality is maintained.

By performing communications complying with the XML-based SAML standard, compatibility among different systems on the web is easily achieved such that installation of additional software or package such as the existing electronic wallet is not needed and easy interworking with applications and data recently moving toward the XML format is provided.

1. An electronic commerce method using a security token comprising:
a transaction approval institution generating a security token based on a security assertion markup language (SAML), using credit information of a purchaser who requests to issue a security token, and transmitting the security token to the purchaser;
the purchaser writing an electronic signature on an order and transmitting the order together with the security token to a seller;
the seller verifying the received order and security token, and then delivering goods according to the order to the purchaser; and
the transaction approval institution performing payment for the seller and the purchaser.

2. The method of claim 1, wherein the generating and transmitting a security token comprises:
based on the SAML, generating the security token by processing the purchaser information as an entity in the form of assertion;
writing an electronic signature in the security token; and
transmitting the electronically signed security token as a part of POST payload to the purchaser.

3. The method of claim 1, wherein the security token is for one-time-use.

4. The method of claim 2, wherein the writing an electronic signature comprises:
writing an electronic signature in the security token by encrypting a result value, which is obtained by performing message digestion, based on a private key of the transaction approval institution.

5. The method of claim 1, wherein the verifying the order and security order and delivering goods comprises:
obtaining a public key of the transaction approval institution from the transaction approval institution;
decrypting the electronic signature based on the public key; and
comparing a first message digest value that is the result of the decryption with a second message digest value that is the result of performing message digestion for the electronic token, and if the first and second message digest values are identical, processing the order according to the purchaser's credit information in the security token.

6. A security token generation system comprising:
a customer information storage unit which stores customer information;
a security token generation unit which if a security token generation request signal is input, searches the customer information storage unit and performs authentication and then outputs a one-time-use security token; and
an electronic signature unit which receives the security token, writes an electronic signature, and outputs the security token to the customer requesting to issue the security token.

7. The security token generation system of claim 6, wherein the security token generation unit generates the security token by processing the customer information as an entity in the form of assertion based on the SAML.

8. The security token generation system of claim 6, wherein the electronic signature unit receives the electronic token, performs message digestion, encrypts the result with a private key of the security token generation system, and outputs the encrypted electronic token.

9. An electronic token generation method of an electronic transaction approval institution based on credit information of a purchaser comprising:
generating a one-time-use security token based on an XML;
writing an electronic signature in the security token; and
encrypting the electronically signed security token as a part of POST payload and transmitting to the purchaser.

10. The method of claim 9, wherein in the generating a one-time-use security token, the credit information is processed in the form of assertion based on SAML.

11. The method of claim 9, wherein the writing an electronic signature comprises:
writing an electronic signature in the security token by encrypting a result value, which is obtained by performing message digestion, based on a private key of the transaction approval institution.
